(19) United States
(12) Patent Application Publication
(10) Pub. No.: US 2008/0105049 A1
(43) Pub. Date: May 8, 2008

(54) Vibrating device with piezo-electrical excitation

(75) Inventors: Siegbert Woehrle, Schiltach (DE); Gerd Ohmayer, Haslach (DE)

Correspondence Address: THE NATH LAW GROUP, 112 South West Street, Alexandria, VA, 22314, US

(73) Assignee: VEGA Grieshaber KG, Wolfach (DE)

(21) Appl. No.: 11/905,159

(22) Filed: Sep. 27, 2007

Related U.S. Application Data
(60) Provisional application No. 60/856,023, filed on Nov. 2, 2006.

(51) Int. Cl. G01F 23/00

(52) U.S. Cl. 73/290 V

(57) ABSTRACT

The invention relates to a vibrating device that is piezo-electrically excited, particularly a fill-level or limit-state measuring device. Its point of departure is a vibrating device that is piezo-electrically excited and that exhibits a membrane (3) which is set into vibration, a piezo-electrical drive device (7) for setting the membrane into vibration or for receiving vibrations from the membrane (3), and a tightening device, such that an initial tightening element (8) belonging to the tightening device is secured to the membrane (3) or is designed to form a single piece with the membrane (3) and such that a second tightening element (9) belonging to the tightening device is so designed that, in interaction with the first tightening element (8), it will brace the drive device (7) against the membrane (3), relative to the first tightening element (8). This vibrating device is advantageous in that the first tightening element (8) is secured, at least partially, so as to encompass the membrane (3) in a contact area to which the drive device (7) is braced against the membrane (3), and in that the second tightening element (9) is so designed as to at least partially encompass the drive device (7) or grip it from behind.

The invention relates to a vibrating device that is piezo-electrically excited, particularly a fill-level or limit-state measuring device, exhibiting the features indicated in the preamble of patent claim 1.

Known from DE 100 23 302 A1 is a piezo-electrically excitable vibrating device which exhibits a membrane that is set in vibration, a piezo-electrical drive mechanism for setting the membrane into vibration, and a tightening device. The tightening device has an initial tightening element, which is secured to the membrane in the form of a bolt or which may form a single piece with the membrane and protrude in the direction of the drive mechanism. This bolt runs through a central hole in the drive mechanism. Furthermore, the tightening device exhibits a second tightening element, which is screwed together at the back with the first tightening element, which takes the form of a threaded bolt, in order to tighten the drive mechanism against the membrane. As a result the first and second tightening elements so interact that the drive mechanism can be braced against the membrane, relative to the first tightening element. In addition, this kind of vibrating device has a shell-like body, which surrounds the drive mechanism. In a hitherto preferred embodiment, therefore, the drive mechanism—which usually takes the form of a plurality of layered drive elements—is tightened against the vibrating membrane by a tie bolt secured to the membrane.

In an alternative embodiment, this kind of shell-like body, which is firmly attached to the outer edge of the membrane, exhibits an internal thread by means of which the drive mechanism is tightened against the membrane using a screwed-in lid component.

Gluing the drive elements to the vibrating membrane is known to the prior art. It is also know, e.g., from EP 11 34 038 A1, to press the drive elements toward a medium which is being measured or monitored and onto the membrane, specifically by means a thread which is located in the rear area of a screw-in fitting, or of spacing sleeve, which leads away from the vibrating device. Also known, e.g., from DE 42 01 360 C2, are drives which are screwed into the area between the paddles of the vibrating fork, which have been lengthened by the membrane.

These design possibilities for the vibrating device have a disadvantage in that the mechanical vibrating amplitude is lowered by the pressure exerted on the vibrating device and/or by temperature and/or by mechanical force and/or by moisture. Adhesively attached drive elements are beset with problems with respect to all these factors.

All commercially available glues are unsuitable for temperatures above 180° C. Expansion of the different materials caused by pressure, temperature, and mechanical load can cause adhesive connections to crack apart or break off.

The drive elements belonging to the drive mechanism and screwed to the membrane with a tie bolt lose mechanical amplitude when there is a pressure load, since pressure deforms the vibrating membrane in the backward direction, the tie bolt is also pushed backwards, and a drive stack consisting of drive elements is consequently relieved of load.

The drive devices screwed forward onto the membrane using a thread applied at the rear of the fitting must primarily contend with the mechanical load on the vibrating device. If, e.g., fork prongs belonging to the vibrating device are pressed apart by, e.g., coarse-grained bulk material or another mechanical load, the drive stack is also relieved of load and the mechanical amplitude drops. Temperature change and moisture penetrating the vibrating system are two problems which beset all of the types of drive mentioned above.

Thus the pressure load exerted on the vibrating device is a problem, as is temperature change or, as the case by be, high temperatures, including those above 250°. The same applies to moisture. In unfavorable cases these factors lead to mechanical and electrical amplitudes in the vibrating system that are unmeasurable or almost unmeasurable.

The goal of the invention is to improve a vibrating device that is piezo-electrically excited, particularly a fill-level or limit-state measuring device, in such a way that it is less susceptible in critical areas to parameters such as pressure, temperature, and moisture. In particular, a solution is sought whereby the drive stack of a drive mechanism is rendered insensitive to mechanical and pressure loads, and the drive element is protected from moisture in the simplest possible manner.

This goal is achieved with a vibrating device that is piezo-electrically excited and that exhibits the features of patent claim 1; or, as the case may be, with a fill-level or limit-state measuring device incorporating such a vibrating device.

Preferred, therefore, is a piezo-electrically excited vibrating device, with a membrane that can be excited into vibration; a piezo-electrical drive mechanism for setting the membrane into vibration or for receiving vibrations from the membrane; and a tightening device, such that a first tightening element belonging to the tightening device is fastened to the membrane or forms a single piece with the membrane and such that a second tightening element belonging to the tightening device is designed so that, in interaction with the first tightening element, it braces the drive mechanism against membrane, relative to the first tightening element; and such that the first tightening element, in an area of contact where the drive mechanism is braced against the membrane, is so fastened to the membrane as to at least partially encompass said membrane, and the second tightening element is designed so as to at least partially grip the drive mechanism from behind or encompass it. In other words, the tightening device basically consists of an initial tightening element, which is attached to the membrane and projects backwards from the membrane so as to encompass the drive mechanism, or its forward portion; and of a second tightening element, which engages with the first tightening element and in the process braces the drive mechanism against the membrane through the walls of the first tightening element. This permits the drive mechanism to be braced against the membrane in a simple manner, while the two tightening elements at least partially clasp or encompass the drive mechanism.

Preferred is a vibrating device in which the second tightening element and the first tightening element can be screwed together by means of their respective threads. This screw connection permits the drive mechanism to be braced against the membrane in a particularly tight and, by preference, detachable manner. In addition, the screw connection allows the drive mechanism to be mounted between the tightening elements and the membrane in manner that provides a seal against the penetration of moisture.

In an initial embodiment it is preferred for the thread of the first tightening element to be an external thread and that of the second tightening element to be an internal thread. The second tightening element is accordingly designed like a lid, e.g., the lid which seals a bottled drink, and can be screwed onto the first tightening element from the back.

In a second embodiment it is preferred for the thread of the first tightening element to be an internal thread and that of the second tightening element to be an external thread. In this embodiment the second tightening element, in the form of a flat, circular body, is screwed into the cylindrically shaped initial tightening element. Here also the screw connection allows the drive mechanism to be braced against the membrane in a particularly tight and simple manner.

It is preferred if the second tightening element has the form of a lid. A lid-like design permits the drive mechanism to be braced against the membrane in a tight fashion, so that after the two tightening elements have been screwed together, and any cable holes have been sealed, moisture is unable to penetrate the space between the tightening elements.

By means of a screw cap, which constitutes the second tightening element and is screwed into position over a threaded ring constituting the first tightening element, the drive stack of the drive mechanism is pressed onto the membrane from the center, using a ball or spherical positioning element, when formerly the tie bolt was cast, or welded, onto the membrane. In the second embodiment, an advantageous alternative envisions the second tightening element as a pressure piece, which is screwed into position. Here the sole disadvantage would be the taller structural height as compared to the first embodiment.

Preferred is a vibrating device in which the first tightening element extends lateral to the drive device and outwards from the membrane. It is also preferred here if the first tightening element has a cylindrical design. This design—involving a first tightening element that is cylindrical in shape—results in a space that is closed circumferentially and toward the front wall of the drive mechanism, facing the membrane, and that has only to be sealed at the back by the second tightening element in order to protect the drive device from the subsequent penetration of moisture.

The present, preferred system takes an approach that is the opposite to that of a prior design for a vibrating device. There a tie bolt is centrally positioned on the membrane and is molded or welded onto said membrane in order to press a drive mechanism against the vibrating membrane by means of a pressure ring. In the present system, a solidly connected threaded ring serving as the first tightening element (or, as the case may be, a threaded ring cast or welded onto a cast-iron fork) rests on what was, in the earlier design, the diameter of a loosely resting pressure ring. In initial tests, the connection between this first tightening element and the membrane has the same diameter as the pressure piece of the prior design. At the same time, the inner area of the first tightening element advantageously serves as the intake housing for the piezo-electrical drive mechanism.

It is preferred if the drive mechanism presses against the central section of the membrane by means of a positioning element. The insertion of such a positioning element as a component or additional part of the drive mechanism permits the transmission of vibrations, in both directions, between the drive mechanism and the membrane, in a position especially close to the axis. At the same time, a positioning element thus designed as a separate component may be advantageously designed as an insulating element, to permit electrical insulation between the drive mechanism and the membrane, when this is desired.

It is particularly preferred if the drive mechanism presses against a section of the membrane using a curvilinear positioning element, particularly one that is partially spherical in shape. It is particularly advantageous when a spherical or semi-spherical form constitutes one section of the positioning element, or represents an independent positioning element, between the drive mechanism and the membrane, since this design permits as small as possible an area of contact for the membrane and thus provides particularly good conditions for the transmission of vibrations. In the opposing direction of curvature or in the case of a spherical or elliptical body, the transmission point is optimized, alternatively or additionally, in the direction of the drive mechanism.

A pressure load on the vibrating device has no effect at all on the mechanical amplitude of the device, since the central pressure point and the drive mechanism's direct screw-connection to the membrane admit no relief of load between the drive mechanism and the membrane.

A preferred version of the vibrating device exhibits at least one vibrating body attached to the membrane in a position opposite the drive mechanism. In a manner known to prior art, a vibrating body serves to amplify vibrations which are transmitted from or to the membrane.

Particularly preferred is an embodiment in which the first tightening element is positioned on the outside, at distance from the rim of the membrane that is greater than that of the vibrating body positioned on the opposite side of the membrane.

Pressing together the prongs of the fork does not cause the mechanical amplitude to drop or relieve the drive mechanism of load. The opposite is the case. Pulling the forks apart is also not critical, since the mounting ring formed by the first tightening element has a relatively small diameter and therefore does not permit deformations large enough to completely relieve the drive mechanism of load.

Preferred is a vibrating device with a housing to whose face the membrane is attached. Behind the membrane, the tightening elements and the drive mechanism are received, at least partially, by a hole passing through the housing.

The hermetically sealed design, with the closed threaded ring combined with a screw-on cap, makes it impossible for moisture, which is harmful to a piezo-drive of this kind, to penetrate the drive mechanism. By also sealing the holes used to connect the drive electrodes in the screw-on cap, which constitutes the second tightening element, and by applying sealing means in the thread of the screw-on cap, the drive mechanism is hermetically sealed and rendered insensitive to moisture. The components and the electrodes for the metal vibrating fork can be easily insulated with an appropriate intake housing made of plastic, e.g., PTFE.

Consequently it possible in the most preferred embodiment for a vibrating device to undergo piezo-electrical excitation independent of temperature, pressure, and moisture, at the same time that the vibrating frequency of the vibrating device is influenced by contact with a medium.

An exemplary embodiment is next described in detail on the basis of the drawing, which shows:

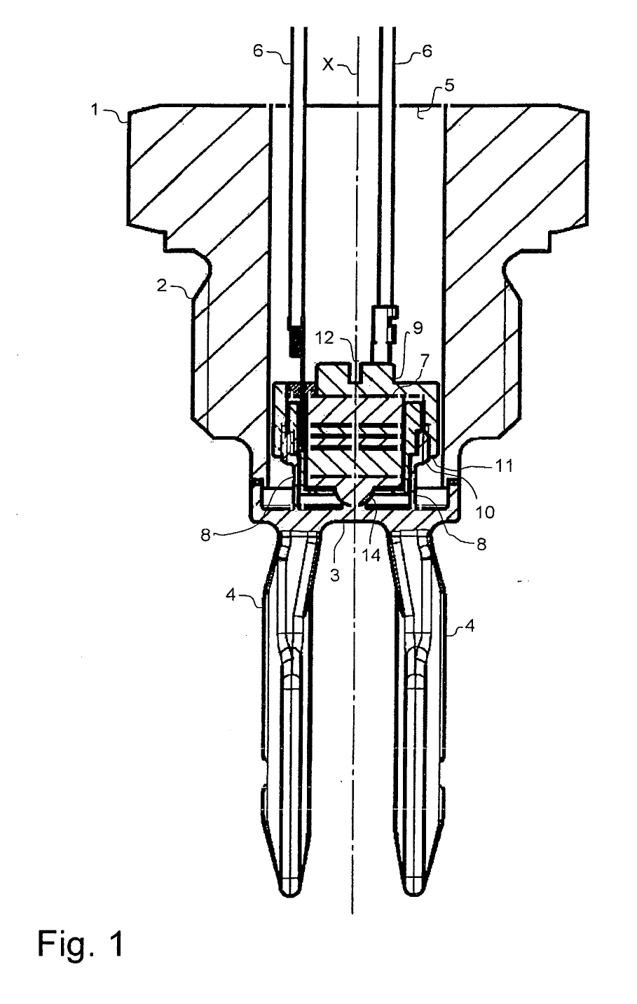

FIG. 1: a depiction in section of an initial embodiment of a preferred vibrating device which is piezo-electrically excited and belongs to a fill-level measuring device

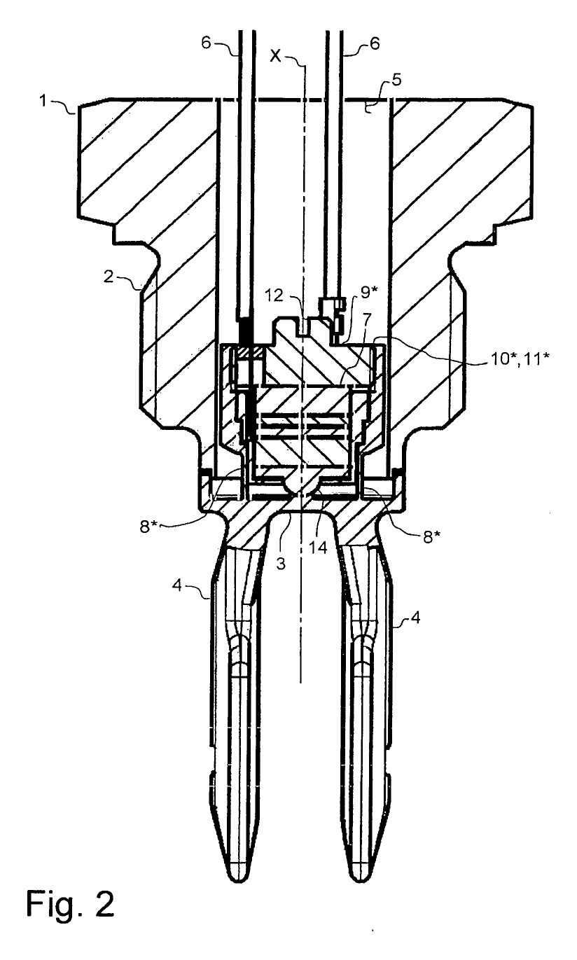

FIG. 2: a depiction in section of a second embodiment of a preferred vibrating device which is piezo-electrically excited and belongs to a fill-level measuring device.

As can be seen in FIG. 1, a vibrating device, which is used principally as fill-level or limit-state measuring device, consists of a number of components. In the following, only those components which are important for an understanding of the preferred embodiments receive a detailed description. Other components, and components described merely in the context of the components of the preferred embodiments, may be replaced by equivalent ones or by components operating in a comparable manner.

A vibrating device of this kind customarily has a housing 1, which exhibits a housing thread 2 along its circumference, in order to fasten the vibrating device into the threaded hole of a container. Attached to the front of the housing 1 is a membrane 3 which, when installed, projects into the container and can be set into vibration. Usually the membrane 3 is attached—and particularly welded—to the front of the housing 1 with a rim that is shaped like a collar at the rear (i.e., towards the housing 1). In the direction of the container the membrane 3 has a vibrating body 4, which is designed, e.g., as a vibrating fork. Customarily the vibrating body 4 is firmly attached—in particular, welded—to the membrane 3. In principle, however, the vibrating body 4 and membrane 3 may be designed as a single piece. Behind the membrane 3, a hole 5 is let through the housing 1 in order to bring other components into the housing 1 from the outside and to lead outwards a connecting cable 6 for a drive mechanism 7. In the depicted embodiment, the drive mechanism 7 consists of a so-called 1-piezo drive, but may also take another form known to the prior art. This kind of drive device 7 customarily consists of a plurality of individual components, which are positioned around a central axis X and which take the form of a drive stack of electrodes and piezo-electrical vibrating components. The central axis X will preferably run in longitudinal fashion through the housing 1 and membrane 3 from the outside inwards, while the vibrating body or bodies 4 will preferably be positioned at equal intervals around the central axis X.

The drive mechanism 7 is tightened against the membrane 3 to permit the vibrations of the drive mechanism 7 to be transmitted to the membrane 3 or the vibrations of the membrane 3 to be transmitted to the drive mechanism 7 (which also and implicitly takes the form of a conventional receiving device). Tightening the drive device 7 against the membrane 3 is performed by a tightening device, which specifically consists of a first and second tightening element 8, 9.

The first tightening element 8 is fastened to the membrane 3 at the back, i.e., so as to project into the housing hole 5. In particular, it may be fastened by means of welding. As an alternative, the membrane 3 and the first tightening element 8 may be designed to form a single piece. The tightening element 8 is designed, dimensioned, and positioned so that it lies at a distance from the central axis X. According to a particularly preferred embodiment, the tightening element 8 is designed as a cylindrical body, which projects from the back of the membrane 3 or is attached to it.

Formed on the outer circumference of the first tightening element 8, specifically in its rear area, is an external thread 10, which makes it possible to screw on the second tightening element 9, which is lid-shaped and provided with an internal thread. The second tightening element 9 has a slot 12 toward the back, i.e., in the housing hole 5, pointing toward the outside of the housing 1; this slot permits the insertion of a screwdriver for screwing the second tightening element 9 into the first tightening element 8. Other designs can be employed to permit this screwing procedure, however. The lid-shaped second tightening element 9 has one or more cable holes 13 to permit the feed-through of the connecting cable 6.

The second tightening element 9 may be constructed of plastic to insulate the back of the drive mechanism 7. In principle, an electrically conductive metal is also possible. An electrically non-conductive material would then be inserted, preferably between inside of the second tightening element 9 and the back of the drive mechanism 7.

This kind of design advantageously permits the drive mechanism to be hermetically sealed from external influences, since the first tightening element 8 and the second tightening element 9 (as a cylindrical or lid-shaped body) tightly seal the drive mechanism 7 between themselves and the membrane 3. The cable holes 13 are sealed with a sealing material after the connecting cable 6 has been guided through them, with the result that moisture cannot pass through the cable holes 13 and reach the area of the drive mechanism 7.

To permit the axially proximate transmission of vibrations between the drive mechanism 7 and the membrane 3, a positioning element 14 is placed between the drive mechanism 7 and the membrane 3. This element 14 may, e.g., take the form of a bolt placed between the drive mechanism 7 and the membrane 3. Particularly preferred, however, are designs in which the positioning element 14, or an element projecting from it in the direction of the membrane 3, is partially spherical in shape or is otherwise curvilinear in design. In this way the transmission of vibrations along the central axis X between the drive mechanism 7 and the membrane 3 is made possible in an advantageous manner.

According to alternative embodiments, a positioning element of this kind can also run from the membrane 3 in the direction of the drive mechanism 7, i.e., in a reverse and curvilinear direction. In yet another alternative, a spherical or elliptical body can be advantageously inserted between the drive mechanism 7 and the membrane 3, in the area of the central axis X, to transmit vibrations between the two components.

An alternative design of the tightening device is next described in accordance with the exemplary embodiment shown in FIG. 2. With respect to the other components, reference is made to the descriptions given for the embodiment shown in FIG. 1.

The tightening device also consists of a first and second tightening element 8*, 9*. In contrast to the first embodiment, however, the first tightening element 8* of the second embodiment has an internal thread 10* and the second tightening element 9* has a matching external thread 11*. As in the first embodiment, the first and second tightening elements 8*, 9* of the second embodiment are screwed together. Here the second tightening element 9*, which is basically flat and circular in shape, is screwed into the back of the cylindrical body of the first tightening element 8*.

According to other exemplary embodiments, which are not depicted in the drawing, other tightening mechanisms are possible for connecting the first and second tightening elements. For example, in place of threads, a locking connection, with one or a plurality of locking teeth, may be provided on one of the tightening elements, and corresponding grooves may be provided on the other tightening element.

It is also possible for the first tightening element to have two or more steps protruding from the membrane, in place of a cylindrical body.

The second tightening element does not have to be designed in the shape of a pot or a sealed cover plate. For example, the second tightening element may take the form of a complete or partial circumferential ring, with a spoke-like bracing inside the circumferential ring. Furthermore, the second tightening element does necessarily have to encompass the rear portion of the drive mechanism. Also possible is a design in which the second tightening element engages with lateral projections from the block of the drive mechanism.

The design can function successfully not only with the depicted 1-piezo drive, but also with a multiple piezo drive, specifically a 2-piezo drive.

1. Piezo-electrically excited vibrating device, with
a membrane (3) that can be excited into vibration,
a piezo-electrical drive mechanism (7) for setting the membrane (3) into vibration or receiving vibrations from the membrane (3), and
a tightening device, where a first tightening element (8; 8*) belonging to the tightening device is fastened to the membrane (3) or forms a single piece with the membrane (3) and where a second tightening element (9; 9*) belonging to the tightening device is designed so that, in interaction with the first tightening element (8; 8*), it braces the drive mechanism (7) against membrane (3), relative to the first tightening element (8; 8*),
wherein
the first tightening element (8; 8*), in an area of contact where the drive mechanism (7) is braced against the membrane (3), is so fastened to the membrane (3) as to at least partially encompass said membrane (3), and
the second tightening element (9; 9*) is designed so as to at least partially grip the drive mechanism (7) from behind or encompass it.

2. Vibrating device according to claim 1, in which the second tightening element (9; 9*) and the first tightening element (8; 8*) can be screwed together with their given threads.

3. Vibrating device according to claim 2, in which the thread of the first tightening element (8) is an external thread (10) and the thread of the second tightening element (9) is an internal thread (11).

4. Vibrating device according to claim 3, in which thread of the first tightening element (8*) is an internal thread (10*) and the thread of the second tightening element (9*) is an external thread (11*).

5. Vibrating device according to claim 3, in which the second tightening element (9; 9*) takes the form of a lid.

6. Vibrating device according to claim 1, in which the first tightening element (8; 8*) leads away from the membrane (3) and extends lateral to the drive mechanism (7).

7. Vibrating device according to claim 6, in which the first tightening element (8; 8*) is cylinder-shaped in design.

8. Vibrating device according to claim 1, in which the drive mechanism (7) presses against a central section of the membrane (3) by means of a positioning element (14).

9. Vibrating device according to claim 1, in which the drive mechanism (7) presses against a central section of the membrane (3) by means of a curvilinear positioning element (14), particularly a semi-spherical positioning element (14).

10. Vibrating device according to claim 1, with at least one vibrating body (4) which is attached to the membrane (3) in a position opposite the drive mechanism (7).

11. Vibrating device according to claim 10, in which the first tightening element (8; 8*) is spaced on the outside at a greater distance from the rim of the membrane (3) than is the vibrating body (4) positioned on the opposite side of the membrane (3).

12. Vibrating device according to claim 1 as component of a fill-level measuring device or a limit-state measuring device

13. Vibrating device according to claim 1, with a housing (1) on whose face the membrane (3) is attached, such that the tightening elements (8, 9; 8*, 9*) and the drive mechanism (7) are received, at least partially, at the back of the membrane (3) by a hole (5) passing through the housing (1).
